(19) United States
(12) Patent Application Publication
(10) Pub. No.: US 2026/0277617 A1
(43) Pub. Date: Sep. 17, 2026

(54) Rehydration for State Management and Task Execution in Notebook Environments

(71) Applicant: Hex Technologies Inc., San Fransisco, CA (US)

(72) Inventors: Ganesh Ramanarayanan, San Carlos, CA (US); Daniel Taylor, Orlando, FL (US); Caitlin Royden Colgrove, San Francisco, CA (US); Glen Takahashi, San Jose, CA (US); Arlo Guneratne Bryer, London (GB); Dylan McCoy Scott, Olympia, WA (US)

(21) Appl. No.: 19/076,881

(22) Filed: Mar. 11, 2025

(51) Int. Cl. G06F 9/44; G06F 40/18

(52) U.S. Cl. CPC G06F 9/44; G06F 40/18

(57) ABSTRACT

A method or a system for dynamic computational state rehydration in a directed acyclic graph (DAG)-based notebook environment. The system initializes a notebook with a fresh kernel. The notebook includes multiple cells, each configured to perform computational operations. The system accesses a DAG representing dependencies between the cells. In response to receiving a request to execute a first cell, a second cell upstream in the DAG, on which the first cell depends, is identified. The system retrieves a sterilized output of the second cell from persistent storage, desacralizes it into an in-memory data structure, and rehydrates the second cell by loading it into the kernel's memory without re-executing the second cell. The first cell is then executed using the rehydrated output of the second cell.

### TECHNICAL FIELD

The disclosure generally relates to directed acyclic graph (DAG)-based notebook environments, and more specifically relates to serialization and rehydration of cell states within the DAG-based notebook environments.

### BACKGROUND

In a notebook environment, users may generate inter-dependent cells for various computational purposes. The cells may operate using different programming languages or schema, and may perform functions based on activity that occurs in other cells. Some cells are implemented using programming languages tuned to executing within provisioned kernel memory to compute function results (e.g., python cells), while others are tuned to query external resources (e.g., SQL (Structured Query Language) cells).

Notebooks typically depend on an active kernel to store variables and computational results in memory. If the kernel is restarted or its state is lost (e.g., when the notebook is reopened or executed in a new session), the entire notebook's code must generally be re-executed to restore the state. Notebooks lack a built-in mechanism to persist and retrieve the computational state (e.g., variables, data frames, intermediate results). Instead, they save only the code, markdown, and static representations of outputs, without retaining live objects or the kernel state.

### SUMMARY

Embodiments described herein relate to systems and methods that address the above-described problems by serializing computational state (e.g., variables, data frames, intermediate results) of a notebook, which can later be used to rehydrate the notebook.

The system initializes a notebook environment with a kernel that is blank or partially blank, and accesses a directed acyclic graph (DAG) structure that represents dependencies between a plurality of cells in the notebook environment. Each cell, when executed, performs a computational operation. The system receives a request to execute a first cell with the plurality of cells in the notebook environment by the blank kernel, and identifies a second cell within the DAG that is upstream from the first cell. Execution of the first cell depends on an output of the second cell. The system deserializes an output of the second cell in a serialized data structure persistently stored in a storage medium into an in memory data structure, and rehydrates the second cell of the notebook environment by loading the output of the second cell in the in-memory data structure into memory of the kernel without re-executing the second cell. The system can then cause the kernel to execute the first cell, using the output of the second cell rehydrated into the memory of the kernel to generate an output.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a system environment for implementing a notebook tool in accordance with one or more embodiments.

FIG. 2 illustrates one embodiment of modules of the notebook tool in accordance with one or more embodiments.

FIG. 3 illustrates an exemplary user interface for generating a cell, in accordance with one or more embodiments.

FIG. 4A illustrates exemplary cells and a corresponding graph representing the relationships between those cells, in accordance with one or more embodiments.

FIG. 4B illustrates another set of exemplary cells in a user interface 430 and a corresponding graph 440 representing the relationships between those cells, in accordance with one or more embodiments.

FIG. 5A illustrates an exemplary user interface for customizing which cells are run in connection with running a given cell, in accordance with one or more embodiments.

FIG. 5B illustrates an example user interface 500B for selecting the execution mode or rehydration mode for a notebook, in accordance with one or more embodiments.

FIG. 6 illustrates a data structure showing context information from a kernel for input into downstream functions, in accordance with one or more embodiments.

FIG. 7 illustrates sub-modules of a query mode module, in accordance with one or more embodiments.

FIG. 8 illustrates sub-modules of a rehydration module, in accordance with one or more embodiments.

FIG. 9 illustrates sub-modules of a serialization module, in accordance with one or more embodiments.

FIG. 10 is a block diagram illustrating components of an example machine able to read instructions from a machine-readable medium and execute them in a processor (or controller), in accordance with one or more embodiments.

FIG. 11 is a flowchart of an example method for dynamic computational state rehydration in a notebook environment, in accordance with one or more embodiments.

### DETAILED DESCRIPTION

Traditional notebook environments rely on executing cells in sequence, requiring upstream cells to be re-executed whenever their dependent downstream cells are run. This dependency on re-execution leads to significant inefficiencies, particularly in computationally intensive workflows or when working with large datasets. If the kernel starts in a blank or partially blank state, users must repeatedly recompute upstream cells to reconstruct the required execution context, consuming unnecessary time and computational resources.

The embodiments described herein address these inefficiencies by introducing a dynamic computational state rehydration method within a DAG-based notebook environment. Instead of re-executing upstream cells, the invention retrieves serialized outputs of upstream cells stored in a persistent medium, deserializes them into in-memory data structures, and rehydrates the upstream cells directly into the kernel's memory. This approach enables downstream cells to execute, leveraging the rehydrated states of upstream cells without redundant computation. By dynamically managing dependencies and efficiently restoring computational states, the invention significantly enhances performance, reduces resource consumption, and improves the user experience in notebook environments.

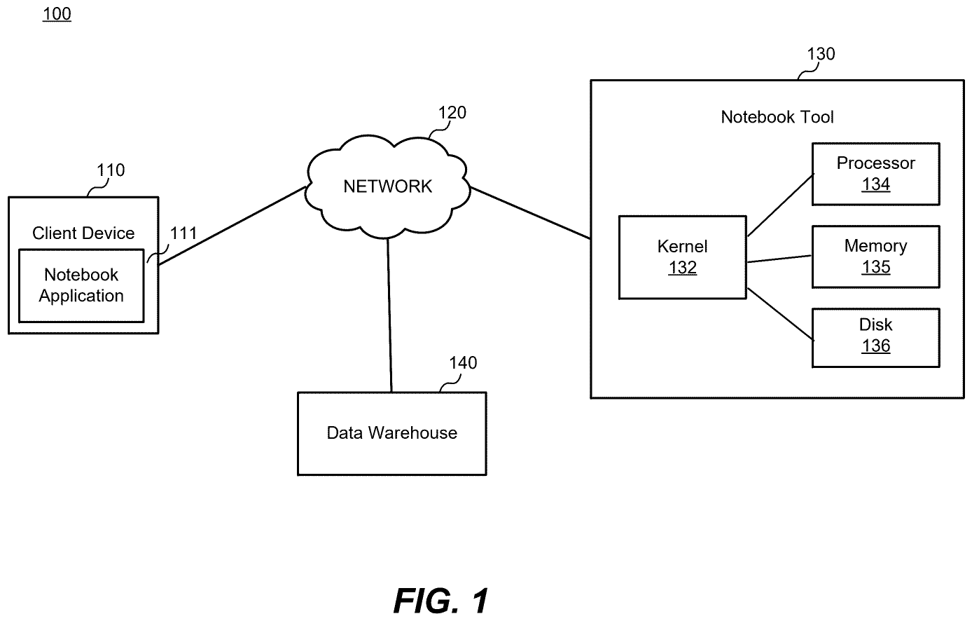

Additional details about the process of serialization and rehydration is further described below with respect to FIGS. 1-9.

### System Architecture

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

FIG. 1 illustrates one embodiment of a system environment for implementing a notebook tool. As depicted in FIG. 1, environment 100 includes client device 110 with notebook application 111 installed thereon, network 120, notebook tool 130, and data warehouse 140. Client device 110 may be any device having a user interface usable to interact with a notebook via notebook application 111 and/or notebook tool 130. Exemplary client devices may include personal computers, laptops, tablets, smartphones, and so on. While only one client device 110 is depicted, any number of client devices may be used. Multiple client devices may be used at a same time to access and otherwise collaborate on a same notebook.

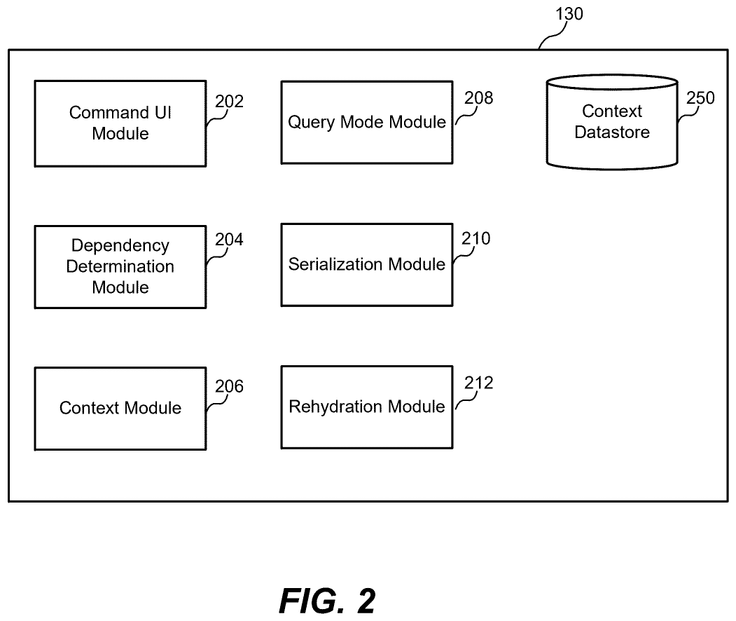

Notebook application 111 may be a dedicated application installed on client device 110 for using a notebook. Notebook application 111 may be installed directly or indirectly from notebook tool 130 (e.g., downloaded from notebook tool 130; downloaded from an application store; from a hard drive having installation code, and so on). The notebook may in whole or in part be stored in the cloud (e.g., using notebook tool 130) and/or local to client device 110. Notebook application 111 may be a browser through which a notebook may be accessed from notebook tool 130. The term notebook, as used herein, may refer to an application that accepts inputs in any number of code languages (e.g., Python, SQL (Structured Query Language), and so on) and/or non-code languages (e.g., spreadsheet format, text format, etc.). The inputs may each form individual cells, or may command combinations of inputs that together form cells. Cells may be connected in a DAG structure, with directed edges pointing between one another that reflect dependencies among cells. The DAG structure and further details about notebook operation are discussed in further detail with reference to FIGS. 2-6. References to activity performed by notebook application 111 are merely exemplary, and that same functionality may, wherever notebook application 111 is referred to, be performed in whole or in part by notebook tool 130. That is, activity described herein as performed by notebook application 111 may be performed on-device, on-cloud (using notebook tool 130), or may be distributed with partial performance by each entity.

Network 120 may be a data communication channel between client device 110, notebook tool 130, and data warehouse 140. The data communication channel may be any channel usable to transmit communications between these entities, such as the Internet, a local area network, a wireless network, a short-range communications network, and so on. Network 120 may facilitate communication between any number of client devices and external servers and services beyond those depicted in environment 100.

Notebook tool 130 may be a cloud-based provider that stores notebooks and provides functionality described herein with respect to notebooks. The notebook tool 130 includes a kernel 132 that is a computational engine that executes code contained in notebook cells. The kernel 132 is configured to run the code, maintain execution state, and provide outputs to users. The kernel 132 acts as a bridge between the code in the notebook tool 130 and the underlying hardware or resources (e.g., processor 134, memory 135, and disk 136). The processor 134 may be CPU and/or GPU configured to perform computations by executing instructions provided by the kernel 132. The memory 135 may be a RAM, which is a temporary storage where data and program states are held during execution. The kernel 132 uses memory 135 to store variables, data structures, functions, and intermediate results while the notebook session is active. All computations performed by the processor 134 access data stored in memory. The kernel 132 also keeps the execution context in memory 135, so the kernel 132 can share state across notebook cells. The disk 136 may be a hard drive, which is a persistent storage medium for files, datasets, and serialized states. The kernel 132 reads data from the disk to load into memory for process.

During operation, the kernel 132 loads code and/or data from disk 136 into memory 135 and instructs the processor 134 to access this data in memory 135 to perform computations. The kernel 132 retains the execution context in memory 135 while a session is active, allowing variables, functions, and other states to remain accessible across cell executions. A session refers to the duration of activity during which a computational environment (such as a notebook kernel) is active and running, encompassing code execution, data processing, and other interactions within a notebook or similar environment.

In some embodiments, when a user opens a notebook, a notebook environment launches a fresh kernel as a process. This process may include allocating memory for the kernel to operate, initializes the runtime environment for the selected programming language or framework, and setting up communication channels between the notebook interface and the kernel. When a fresh kernel starts, the memory normally has no prior states or variables or execution contexts from previous sessions. The kernel is associated with the notebook session and begins listening for commands sent from the notebook cells.

Conventional notebook tools depend on an active kernel to store variables and computational results in a memory. If the kernel is restarted or its state is lost (e.g., when the notebook is reopened or executed in a new session), the entire notebook's code must be re-executed to restore the state. These notebooks lacks a built-in mechanism to persist and retrieve the computational state (e.g., variables, data frames, intermediate results). Instead, they save only the code, markdown, and static representations of outputs, without retaining live objects or the kernel state.

Unlike such convention notebook tools, during or at the end of the session, the kernel 132 can save results, code, and states from memory back to disk 136. The code may be stored in a notebook, and the states may be serialized before being persistently stored on disk 136. The serialized states may later be retrieved by the kernel 132 when a new session starts, either by the same user or a different user, on the same client device 110 or a different client device. During the new session, the kernel 132 may retrieve the previously serialized states from disk 136 without re-executing the code, a process referred to as rehydration. The rehydrated cell behaves as if it has just been executed during the session, and its output can be used as input for downstream cells.

In some embodiments, the serialized states may be stored in the data warehouse 140 or client device 110. In some embodiments, query results and intermediate query results may be serialized and stored in the data warehouse 140, while the remaining computational outputs are stored at a server or device hosting the notebook tool 130 and/or the client device 110. For example, when a query is part of larger computations (e.g., joins or aggregations), the intermediate states or results can be serialized for future reuse or incremental computations. In some embodiments, users can specify where the serialized data is to be stored or designate specific types of serialized data (e.g., query results) to be stored in particular locations (e.g., the data warehouse 140).

All functionality described herein with respect to notebook application 111 may be performed by notebook tool 130, and all functionality described herein with respect to notebook tool 130 may be performed by notebook application 111 in part or in whole. Distributed processing where some activity described is performed by notebook application 111 and other activity described is performed by notebook tool 130 is implied as within the scope of what is described even where processing is only described with respect to one of the two entities herein. Further details about the functionality of notebook tool 130 are described below with respect to FIG. 2.

Data warehouse 140 is depicted as one data warehouse and is recited in the singular, but may include any number of data warehouses provided by any number of providers, which may use their own schema in storing and querying data. Notebook application 111 may be provisioned with a data connector that translates commands from a schema used by notebook application 111 to be compatible with data warehouse 140. Each respective data connector may support and translate bidirectional communications between notebook application 111 and a respective data warehouse 140. Notebook application 111 may use dedicated memory (e.g., memory of client device 110 and/or cloud memory provisioned by notebook tool 130) for local functions, such as processing python script. Notebook application 111 may use memory of data warehouse for remote functions such as data queries and data synthesis. Further details about optimally splitting workloads between notebook application 111 and data warehouse 140 is discussed in further detail below.

FIG. 2 illustrates one embodiment of modules of the notebook tool. As depicted, notebook tool 130 includes command UI (user interface) module 202, dependency determination module 204, context module 206, query mode module 208, serialization module 210, rehydration module 212, and context datastore 250. The modules and datastores depicted in FIG. 2 are merely exemplary; any number of modules and/or datastores may be used to achieve the functionality disclosed herein. Moreover, as mentioned above, while the modules and datastore are illustrated and described with respect to notebook tool 130, some or all of the operation of these modules and/or datastores may part of notebook application 111 operating on client device 110, thus accommodating on-device operation in whole, or distributed processing between notebook application 111 and notebook tool 130.

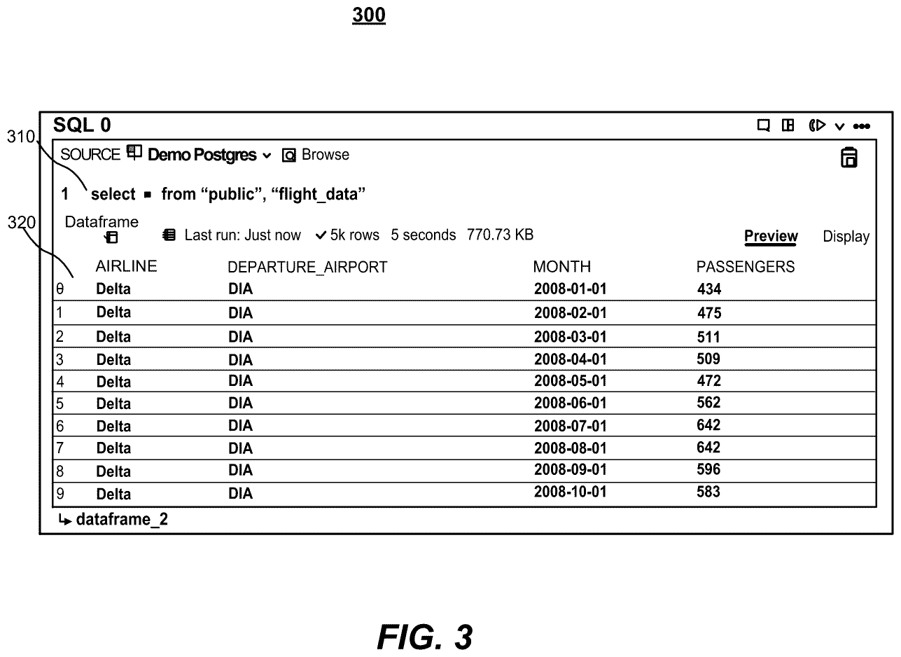

Command UI module 202 receives inputs in cells of a notebook. Turning for the moment to FIG. 3, FIG. 3 illustrates an exemplary user interface for generating a cell, in accordance with an embodiment. User interface 300 may include multiple cells each having their own interface, where different cells may be used to generate code versus generating markdown (e.g., tables, text, etc.) versus generating SQ and so on. These are merely exemplary; any number of cells may be generated or part of user interface 300, and the cells may use any language (other code languages like Python, natural language, spreadsheet, or any other language is within the scope of the disclosure). As depicted, user interface 300 shows a selection of a source of “Demo Postgres”, which is a data warehouse of data warehouse 140. Interface 310 accepts input in a native language to notebook application 111, such as python, to perform a command. The command in this case is to select all rows of public flight information from a dataframe called flight_data. Interface 320 may preview or do a full display of the results of the command being executed.

Cells may be generated from scratch or may be generated using pre-existing components. To use pre-existing components, user interface 300 may display a selectable component option (not depicted), which may lead to a library of components. A user may select from the library a component, and responsive to doing so, command UI module 202 will add the component as a cell to user interface 300. For example, rather than type in the python script to access the flight data, a user may have selected a component with the python script already populated. To generate cells from scratch, in an embodiment, a user may add text to the cell's associated interface (e.g., manually type code, SQL, markdown, python, and so on).

In an embodiment, command UI module 202 may receive a natural language command to automatically generate code. For example, command UI module 202 may receive a command to “obtain public flight data from postgres”. Responsive to receiving such a command, command UI module 202 may pass as input to a supervised machine learning model, such as a generative machine learning model, the command, and may receive as output from the supervised machine learning model a response which command UI module 202 uses to form the code in the cell.

In a notebook structure having many cells that have myriad dependencies, considering state of dependent cells is required to avoid inaccuracies where the cell implicated by the request depends on other cells. Thus, the context of dependent cells is considered in processing commands within a cell. Dependency determination module 204 determines dependencies of the cell, and command UI module 202 may additionally pass the dependencies and/or the cells on which the command cell depends to whatever function is executing the cell.

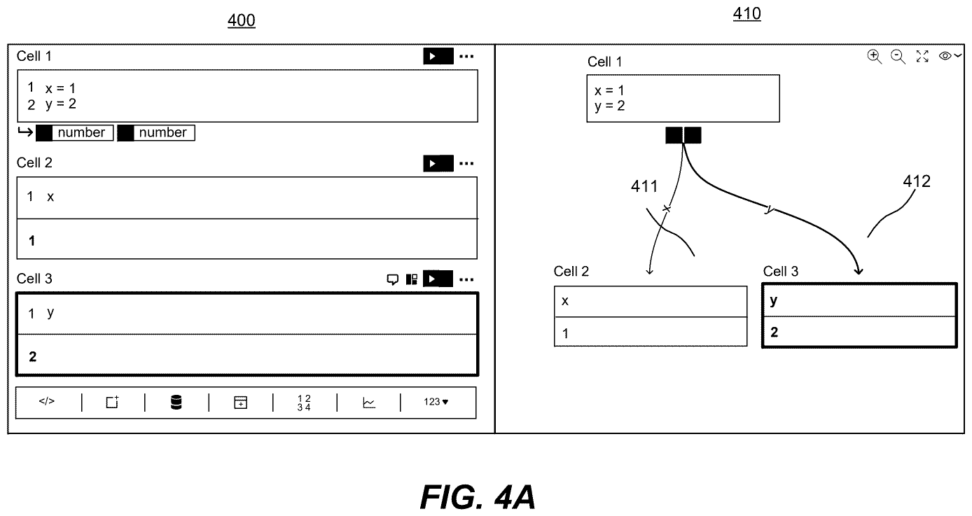

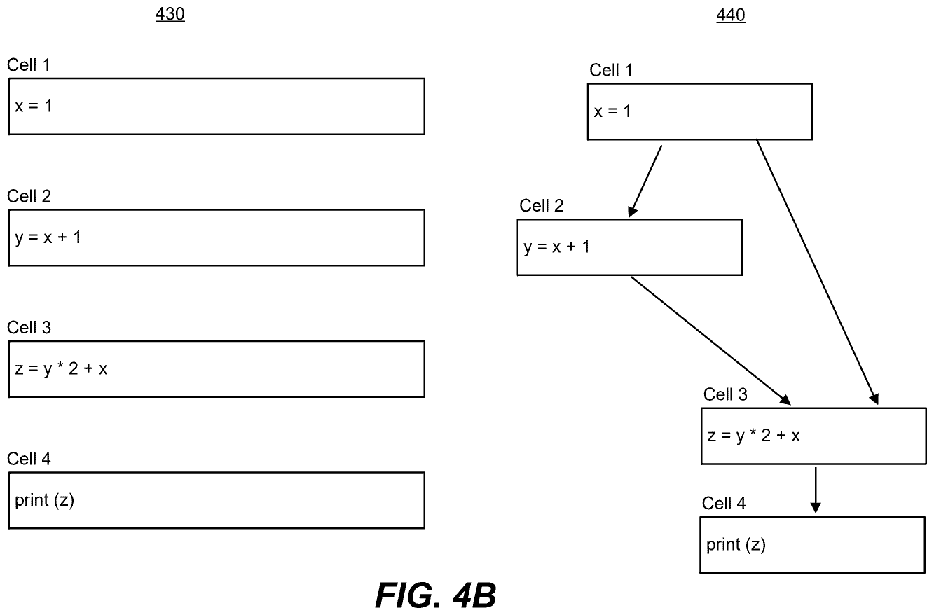

To illustrate graph dependencies in a DAG used by notebook tool 130, we turn to FIGS. 4A and 4B. FIG. 4A illustrates exemplary cells and a corresponding graph representing the relationships between those cells. User interface 400 displays three cells: cell 1 defines x=1 and y=2; cell 2 references and displays the value of x; and cell 3 references and displays the value of y. Notebook tool 130 automatically identifies dependencies between the cells. Specifically, it determines that cell 2 and cell 3 depend on cell 1, as the values of x and y in cells 2 and 3, respectively, are defined in cell 1. This dependency relationship is visually represented in graph 410, where directed edge 411 connects cell 1 to cell 2, and directed edge 412 connects cell 1 to cell 3. Whenever the values of x or y in cell 1 are updated, the directed edges prompt notebook tool 130 to automatically update the corresponding values in cells 2 and/or 3, depending on which variable(s) are affected.

FIG. 4B illustrates another set of exemplary cells in a user interface 430 and a corresponding graph 440 representing the relationships between those cells. User interface 430 shows four cells:
cell 1 defines x=1;
cell 2 defines y=x+1;
cell 3 defines z=y*2+x; and
cell 4 executes print(z).

Here, notebook tool 130 automatically determines the dependencies among these cells. In particular, cell 2 depends on cell 1, as the value of y is calculated using x, which is defined in cell 1. Cell 3 depends on both cell 1 and cell 2, as the value of z is calculated using x and y. Cell 4 depends on cell 3, as it uses the value of z for its output. These dependencies are visually represented in graph 440, where directed edges connect cell 1 to cell 2, cell 1 to cell 3, and cell 2 to cell 3 to reflect the dependencies of x and y. An additional directed edge connects cell 3 to cell 4, indicating that cell 4 depends on the output of cell 3. Whenever the value of x in cell 1 is updated, the notebook tool 130 updates cells 2, 3, and 4 based on the directed edges in the dependency graph. Similarly, if the value of y in cell 2 is modified, the corresponding downstream cells 3 and 4 are automatically recalculated to ensure consistency.

In order to successfully implement a DAG structure in a notebook environment, all directed edges between cells must flow in only one direction (to prevent an infinite loop). For example, a DAG is broken in a scenario where a notebook has a first cell that defines x=1 and y=x+1, and a next cell that defines x=y+1 because the cells are interdependent. To avoid an infinite loop in such a scenario, notebook tool 130 employs linear ordering, where whichever cell is introduced first in the notebook controls, and the next cell in the infinite loop is dependent on the prior cell. Thus, in the prior example, a directed edge would be drawn from the first cell to the next cell, and no directed edge would be drawn back to the first cell from the next cell.

In order to successfully implement a DAG structure in a notebook environment, the ordering must be deterministic. For example, consider a scenario where there are two cells that each define a variable x. The first cell defines x=1, and the second cell defines x=2. A function of print(x) appears in a third cell. For the DAG to be successfully implemented such that what is printed from the print(x) function is reliable and repeatable, linear ordering is once again used between cells calling a same variable. Thus, in this example, notebook tool 130 would draw a directed edge from x=1 to x=2 to print(x), and the print(x) example would reliably use the value of 2 for x.

With a DAG structure established for a notebook, when a cell is run, dependency determination module 204 may determine, using directed edges of the graph structure, a set of precedent cells from which the code cell depends. That is, as a default, before or in connection with running the cell, dependency determination module 204 may traverse directed edges of the graph structure. The traversal may result in one or more of running each precedent cell that is connected to the cell to be run by a directed edge and/or returning an identification of each precedent cell. Where each precedent cell is run, values for cells (e.g., values of variables within cells, values determined by functions within cells, and so on) may be written to context datastore 250. Further detail about use of context datastore 250 is described in further detail below with respect to context module 206.

In an embodiment, running dependency determination module 204 may occur as a default when a cell is run. Dependency determination module 204 may, optionally, additionally run stale cells relating to the cell when the cell is run. The term “stale”, as used herein, refers to a state of a given cell any of the following is true: (1) the cell has not yet been run in a current kernel session; (2) an upstream cell has been edited but the given cell not been re-run; (3) an upstream cell has been run more recently than the given cell itself; and (4) an upstream cell has become stale. For example, returning to the example of cell 1, which defines x=1 and y=2, cell 2 having a value of x, and cell 3 having a value of y, if cell 1 was run more recently than cells 2 or 3, cells 2 and 3 are stale. Stale upstream ancestor cells (that is, cells that are pointed to by a directed edge from a more recently run cell) may be re-run along with precedent cells from which a code cell depends.

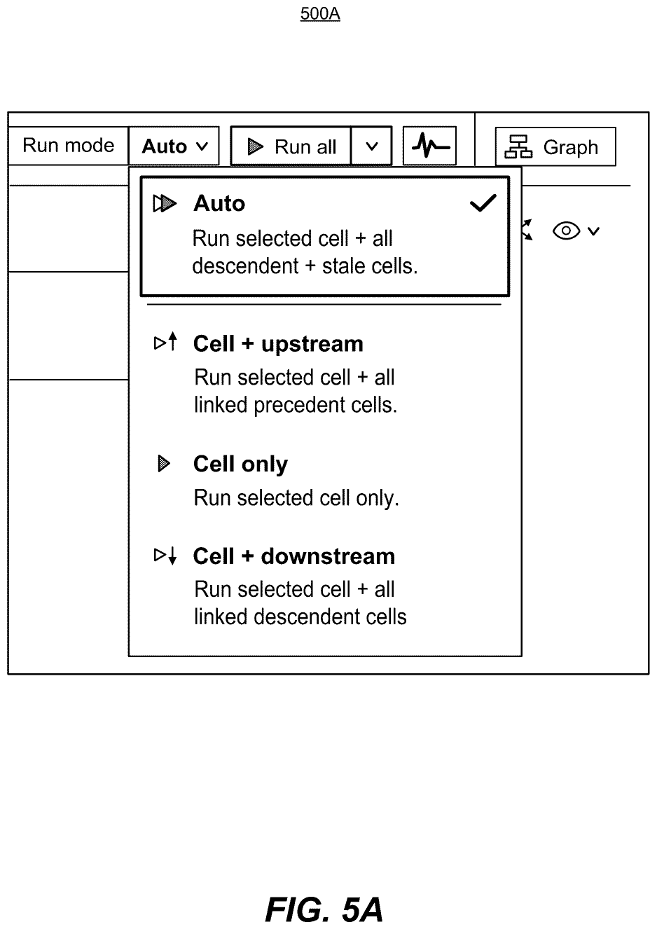

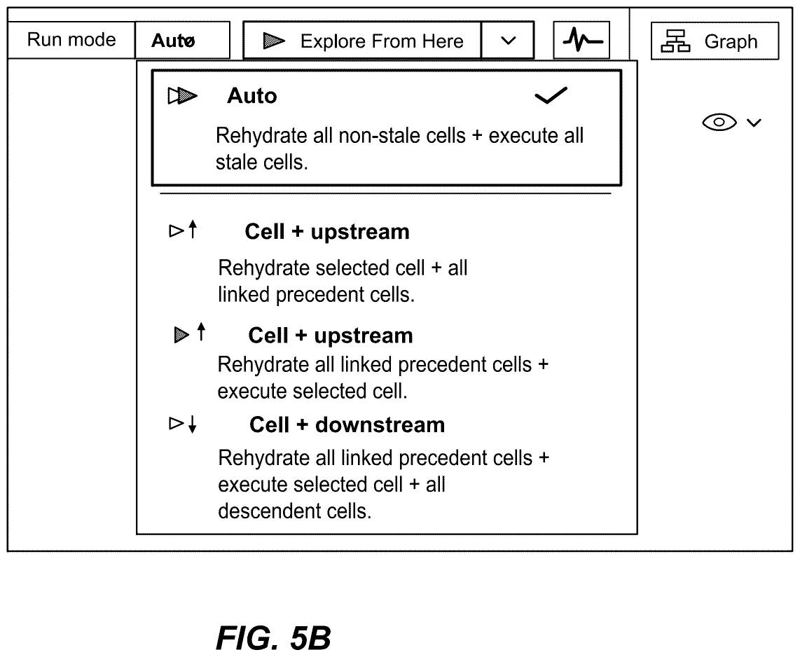

Turning for the moment to FIG. 5A, FIG. 5A illustrates an exemplary user interface 500A for customizing which cells are run in connection with running a given cell. As depicted in user interface 500A, a default may be set as described, where when a selected cell is run, its descendent cells and respective stale cells are run. Other options, however, are available. Application 111 may enable a user to select running a selected cell and its linked precedent cells, just the cell itself, or the cell and its linked descendent cells, at the user's option. A selected option may be incorporated by application 111 as a new default operation for a given cell or for all cells until a new default is selected by a user. These selections may be applied whether in local mode or in query mode.

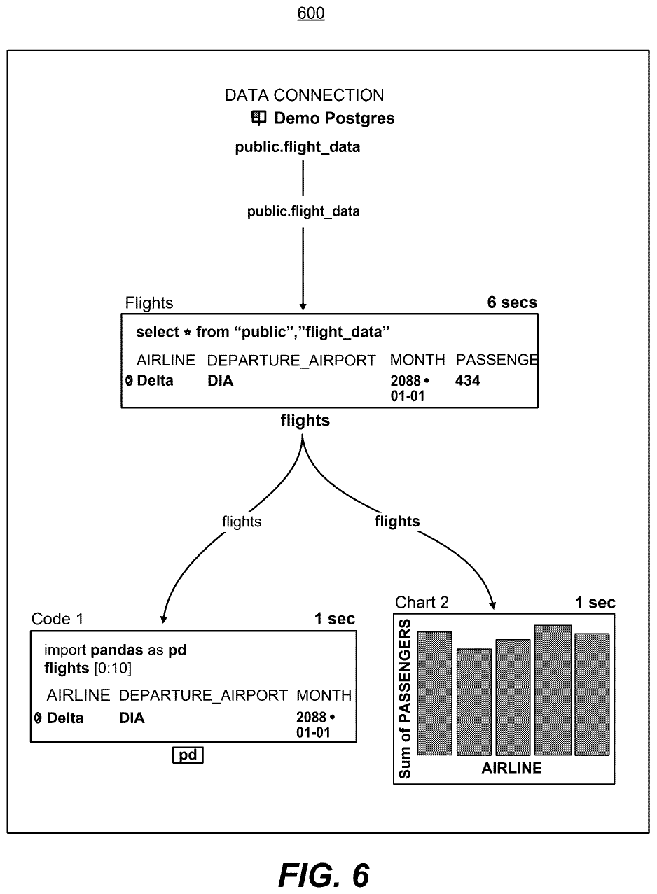

Context module 206 keeps track of data stored (contextual schema) in the kernel. The data stored in the kernel may reflect variable values, cell values, cell states (e.g., stale/not stale), cell dependencies, and so on. Context module 206 may also keep track of data frames (e.g., tables) and sub-components therein (e.g., values of data sets within a data frame). An example of context is shown in FIG. 6, where FIG. 6 illustrates a data structure showing context information from a kernel for input into downstream functions. Graph 600 shows a dependency graph, where a top-level cell retrieves data from postgres and populates a dataframe of flight_data. The next cell down depends on the top-level cell that is selecting public data from the flight data. Two cells branch from there, the left importing from the selected data the first ten rows into a data schema of pandas. Through this process of constructing and running cells in the graph, context module 206 maintains a cache of metadata describing each cell including values associated with each given cell. Therefore, when a lower-level cell is run, it is not necessary to re-run higher-level cells, as context module 206 may instead determine that the higher-level cells are not stale and may return values from those higher-level cells from a prior run that is stored in the cache, rather than needing to re-run those cells.

Returning to FIG. 2, serialization module 210 is configured to persistently store computational states from the kernel 132 to disk 136 by serializing cell data, variable values, and execution context into a format suitable for later retrieval. The serialization process involves converting in-memory objects, such as data frames or intermediate results, into a storable structure that can be saved to disk 136 and accessed independently of the active session. This allows the notebook tool 130 to preserve the state of a cell or a set of cells. The serialized states can later be retrieved during future sessions by the rehydration module 212, enabling efficient rehydration of cells without the need to re-execute upstream dependencies.

In some embodiments, the serialization module 210 determines which in-memory objects or data structures (e.g., variables, lists, dictionaries, arrays, tables, data frames) need to be serialized, and selects a serialization format based on the data type or data structure. The serialization formats may include (but are not limited to) binary formats (e.g., Pickle in Python, Protocol Buffers), text-based formats (e.g., JSON, XML, CSV), and domain-specific formats (e.g., Parquet for tabular data). The serialization module 210 is configured to convert in-memory objects into the selected serialization format and write the serialized data into a persistent storage medium, such as a file on disk, a database (e.g., context datastore 250), or a cloud storage service (e.g., data warehouse 140).

Rehydration module 212 retrieves previously serialized states from disk 136 and deserializes them into the kernel memory 135 when a new session starts. This process is also referred to as “rehydration,” much like adding water (hydration) to something that was previously dried or preserved. In some embodiments, the rehydration module 212 determines which cells to rehydrate based on input from the context module 206. The context module 206 evaluates the dependency graph to identify relevant cells. The rehydrated cells behave as though they have been freshly executed, allowing their outputs to serve as inputs for downstream cells. By bypassing redundant computations and leveraging serialized results, rehydration capability significantly enhances notebook performance.

In some embodiments, the context module 206 is configured to identify a number of cells dependent upon by a current cell to be executed by analyzing the DAG structure of the notebook. Responsive to receiving a user input that selects a cell for execution, the context module 206 may traverse the DAG upstream from the selected cell, following the directed edges to identify all precedent cells that the selected cell depends on. In some embodiments, for each identified precedent cell, the context module 206 determines whether the cell is fresh, stale, or not stale. If a cell has already been executed in the current session and its output has not changed (or been invalidated by edits to upstream cells), it is deemed “fresh” and does not need to be re-executed or rehydrated. If a cell's state is invalid (e.g., due to edits in an upstream dependency), it is deemed “stale” and needs to be re-executed. If a cell has already been executed in a previous session and its output has not changed (or been invalidated by edits to upstream cells), it is deemed “not stale”, and can be rehydrated.

In some embodiments, the context module 206 may exclude precedent cells that are fresh or otherwise do not directly influence the execution of the current cell. For instance, such filtered out cells may include precedent cells that are not immediately related to the current cell but are further upstream in the dependency chain. The remaining precedent cells form a minimized subset that directly impacts the current cell. In some embodiments, the context module 206 evaluates the execution context of each cell (e.g., variable values, data frame states) using metadata stored in the context datastore 250. In response to determining the minimal set of dependent cells, the context module 206 may generate a rehydration plan and cause the rehydration module 212 to rehydrate the identified minimal set of precedent cells base on the rehydration plan. The current cell is executed only after all necessary dependencies are resolved.

For example, referring back to FIG. 4B, cell 1 defines x=1, cell 2 defines y=x+1, cell 3 defines z=y*2+x, and cell 4 defines print(z). In response to receiving a user selection of cell 4 for execution, the context module 206 identifies cells 1, 2, and 3 as potential dependencies based on the DAG and evaluates their states. Based on this evaluation, the context module 206 determines which cells require rehydration before executing cell 4. In some embodiments, the context module 206 identifies a minimal set of precedent cells that are to be rehydrated and rehydrates only those that are necessary. For instance, since cell 4 directly depends on cell 3, the context module 206 may determine that rehydrating cell 3 alone is sufficient if cell 3 is not stale. Thus, even though the precedent cells include cells 1-3, the minimum subset of cells that needs to be rehydrated is cell 3. As another example, if some of the precedent cells are fresh (i.e., executed during the current session), they also don't need to be rehydrated.

If cell 3 is determined to be stale, the context module 206 may decide that cell 3 should not be rehydrated but instead re-executed before executing cell 4. Cell 3 can become stale in various scenarios, including updates or re-executions of its upstream or precedent cells (cells 1 and 2), modifications to its dependencies, direct edits to its code, external changes affecting its inputs, or manual invalidations. For instance, if cell 1 or cell 2 is modified (e.g., their code is altered or new values are assigned), cell 3 becomes stale as its computations are no longer synchronized with the updated precedent cells.

Additionally, if the dependencies of cell 3 are changed—such as adding a new dependency or removing an existing one—cell 3 becomes stale due to its altered execution context. This type of dependency change may result from edits made to the code within cell 3 itself. For example, if the code in cell 3 is modified from z=y*2+x to z=2*x, the cell becomes stale because its previous output is invalid and its dependencies (cell 1 and/or cell 2) may no longer be relevant.

If the context module 206 determines that cell 3 must be re-executed due to one or more of the aforementioned reasons (or additional reasons), it evaluates the states of its precedent cells (cells 1 and 2) to determine whether they require rehydration or re-execution. For example, if neither cell 1 nor cell 2 is stale, the context module 206 may instruct the rehydration of both cells before proceeding with the execution of cell 3. Alternatively, if cell 1 is not stale but cell 2 is stale, the context module 206 may decide to rehydrate cell 1 and re-execute cell 2 prior to executing cell 3.

In scenarios with complex dependencies, this process may be performed iteratively or recursively to identify the minimal set of cells that require rehydration and the minimal set of cells that require re-execution, ensuring optimal preparation before executing the target cell.

In addition to the states of precedent cells, the context module 206 may also consider other factors in determining whether a cell should be rehydrated or re-executed. Such factors may include computational costs, data size and complexity, and type of operation performed by the cell. For example, in some embodiments, if rehydration (deserialization from disk) is computationally faster than re-execution, rehydration may be preferred. On the other hand, for cells performing lightweight operations, re-execution may be quicker and easier than deserializing, thus, re-execution may be preferred. Alternatively, or in addition, for large datasets or outputs, rehydration from a serialized state may be faster and/or more memory-efficient than re-executing a cell, thus, rehydration may be preferred. Further, cells with random outputs or external dependencies (e.g., API calls, timestamps) may be re-executed to ensure accurate results. In some embodiments, users may be able to input their preference. For example, if a user selects a “rehydrate” or “re-execute” mode for a cell, that preference may override other considerations. In some embodiments, users may define custom execution modes to selectively rehydrate or re-execute based on their workflow needs.

In some embodiments, a rules table or heuristic algorithm may map certain functions or operations to either rehydration or re-execution. For example, data frame queries (SQL filters) may prefer rehydration; operations with random outputs may prefer re-execution. If an error occurred during a previous execution of a cell, re-execution may be required instead of rehydration to ensure proper results. In some embodiments, patterns from previous runs may influence the choice. For instance, cells rarely being modified might be better off rehydrated if results are serialized; if a user frequently modifies certain cells, re-execution may be preferred for those cells.

In some embodiments, the decision to rehydrate or re-execute may depend on current system resources, such as CPU, memory, or disk I/O constraints. If multiple users are collaborating on a same notebook, the system may prioritize rehydration to ensure consistency across users. For cells that are part of a query chain in a data warehouse, rehydration may be preferred to leverage cached results. If the query results are already optimized for the data warehouse schema, rehydration may be faster than recomputing within the kernel.

FIG. 5B illustrates an example user interface 500B for selecting the execution mode or rehydration mode for a notebook, in accordance with one or more embodiments. The user interface 500B includes a dropdown menu titled “Run mode,” which provides users with multiple options for executing or rehydrating a selected cell and its related cells. These options include an “Auto” option (which rehydrates all non-stale cells and executes all stale cells), a “Cell and Upstream” option (which rehydrates the selected cell and all linked precedent cells), another “Cell and Upstream” option (which rehydrates all linked precedent cells and executes the selected cell), and a “Cell and Downstream” option (which rehydrates all linked precedent cells, executes the selected cell, and runs all descendent cells). Note that these options are merely a few examples; additional or different options may be available. In some embodiments, users can define their own options.

The GUI 500B also includes an “explore from here” function that allows users to interact dynamically with a notebook, starting from a specific cell, without requiring the re-execute all preceding cells. When a user selects a cell and activates the “explore from here” function (e.g., press the “explore from here button), the notebook tool 130 identifies and rehydrates a minimal set of relevant upstream cells that are directly precedent to the selected cell, restoring the necessary computational context. This feature leverages serialized states of the upstream cells, allowing for efficient rehydration and avoiding redundant computations. By skipping the re-execution of non-stale cells and directly rehydrating their outputs, “Explore from here” feature significantly enhances computational performance and real-time exploration experience.

Returning back to FIG. 2, while context module 206 enables running and rehydrating cells using notebook tool 130 to be an efficient process, jobs may be encountered that are either suboptimal or impossible to run or rehydrate using limited allocated kernel resources available to notebook application 111. In particular, running or rehydrating cells relating to large data frames in the kernel (e.g., a billion rows) may require more memory than is available to notebook application 111. To this end, a query mode may be operated, run or rehydrate by query mode module 208, to efficiently transfer the load to data warehouses 140 when appropriate to do so, where data warehouses 140 are tuned to efficiently perform the computation that is suboptimal for notebook application 111 to perform.

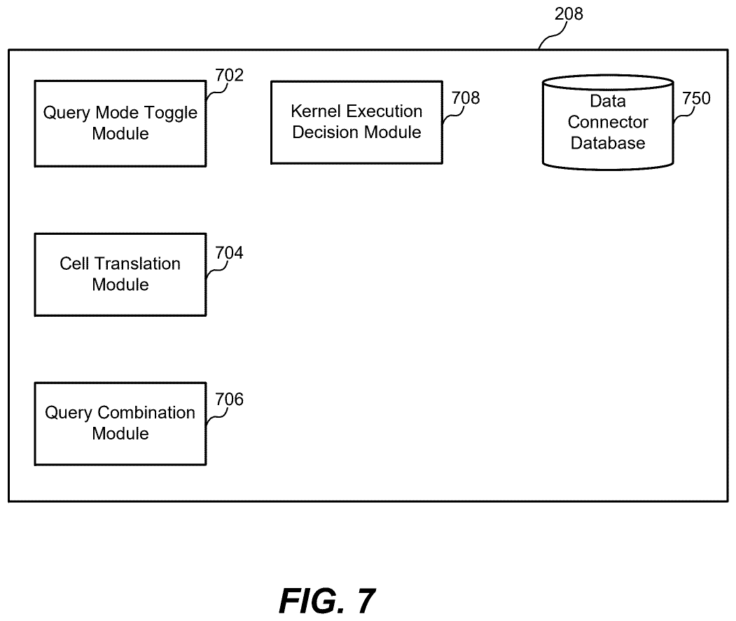

FIG. 7 illustrates one embodiment of sub-modules of a query mode module. As depicted, query mode module 208 includes query mode toggle module 702, cell translation module 704, query combination module 706, kernel execution decision module 708, serialization module 710, rehydration module 712 and data connector database 750. The sub-modules and databases depicted with respect to FIG. 7 are merely exemplary, and more or fewer modules and/or databases may be used to achieve the functionality disclosed herein.

The term local mode, as used herein, refers to the operation of cells within notebook application 111 where cells are executed using kernel memory or rehydrated from serialized data stored on a disk coupled to notebook application 111 or notebook tool 130. Conversely, the term query mode refers to the operation of cells offloaded from notebook application 111 to a data warehouse 140 for execution or rehydration.

As previously described, serialized data may be stored on the client device 110, on the device hosting notebook tool 130, or at the data warehouse 140. In some embodiments, users may specify a location for storing serialized data. In some embodiments, users may specify a location for a specific type of serialized data. For example, query results may be serialized and stored at the data warehouse 140, and pure computations may be serialized and stored at the device that hosts the notebook tool 130 or the client device 110.

In some embodiments, the local mode is further divided into a local execution sub-mode and a local rehydration sub-mode. The term local execution sub-mode refers to the operation of notebook application 111 where cells are, by default, executed using kernel memory unless explicitly specified to run using the data warehouse 140. The term local rehydration sub-mode refers to the operation of notebook application 111 where cells are, by default, rehydrated from serialized data unless marked as stale or explicitly specified to be executed via the kernel or the data warehouse 140.

In some embodiments, the query mode is further divided into query execution sub-mode and query rehydration sub-mode. The term query execution sub-mode refers to a mode where notebook application 111 dynamically determines, as a cell is requested for execution, whether the cell would be more efficiently executed using the kernel or offloaded to the data warehouse 140. The term query rehydration sub-mode refers to a mode where notebook application 111 dynamically determines, as a cell is requested for execution, whether the cell should be rehydrated from serialized data stored at the data warehouse 140.

The term trigger, as used herein, refers to a condition that instructs the query mode toggle module 702 to switch between local mode and query mode or between their respective sub-modes when encountered.

The query mode toggle module 702 may detect a trigger based on input into a notebook interface relating to a data frame. In one embodiment, the trigger may be detected based on the input being an express command to enter query mode. For example, the notebook application 111 may generate a selectable option for display (e.g., using interface 500A or 500B) that a user can select to run in query mode. Upon detecting the selection of this option, the query mode toggle module 702 may identify the trigger and toggle into query mode. In some embodiments, the context module 206 automatically determines whether query execution.

Similarly, the notebook application 111 may generate a selectable option to toggle back to local execution mode and local rehydration mode. Upon detecting the selection of this option, the query mode toggle module 702 may toggle from query mode to local execution mode or local rehydration mode.

In an embodiment, query mode toggle module 702 may detect the trigger automatically. For example, when a cell is requested to be run, query mode toggle module 702 may determine a size of the request and an amount of available memory. Responsive to determining that the amount of available memory is insufficient to perform the size of the request, query mode toggle module 702 may detect the trigger. In an embodiment, the automatic detection may occur when a dataframe cell is run, where the size that is determined is a size of a dataframe (e.g., size can be measured based on storage space required or other metrics, such as amount of rows). In an embodiment, rather than compare to an amount of available memory, query mode toggle module 702 may compare the size to a threshold (e.g., the threshold can be amount of storage space required, number of rows in a data frame, and so on). Where the size exceeds the threshold (e.g., threshold is 1 million rows; amount of rows needed to run cell is compared to 1 million rows, and if greater than 1 million rows, the threshold is exceeded), query mode toggle module 702 may detect the trigger and may automatically toggle from local mode to query mode.

While in query mode, cell translation module 704 receives input of a query into a cell within the notebook interface, the query relating to the dataframe. The query may call a dataframe, or may perform a function on the dataframe (e.g., pivot, filter, etc.). Cell translation module 704 detects the cell and determines to translate the input into a data warehouse query language. The query, as received, may be written in native code of notebook application 111 used to run a process on kernel memory of notebook application 111 (e.g., a python query, a kernel-oriented SQL query, etc.). Data warehouse query language may be query language that is tailored for querying a data warehouse. For example, the cell may already have query language within it, and cell translation module 704 may rewrite that query language for use in a data warehouse (e.g., by chaining SQL queries together from upstream cells). As another example, input into a UI such as a natural language input intended for execution on the kernel may be translated into a SQL query where query mode is active. Cell translation module accesses a data connector for the dataframe from data connector database 750, the data connector having instructions for translating native code into a schema of data warehouse 140 that houses the dataframe.

A major premise of query mode is that, when querying and then fine tuning queries for a dataframe, there is no need to use kernel resources of notebook application 111 to locally load the dataframe or a portion thereof. This is because a user of notebook application 111 is likely to continue fine tuning results until the results are suitable for performing a function, such as generating a graph from a filtered set of data of the dataframe. To this end, rather than load the dataframe at each query, notebook application 111 may instead simply display a preview (e.g., as shown in user interface 300 of FIG. 3). Moreover, because subsequent queries may build on prior queries, query mode may leverage context of prior queries and combine those prior queries into a next query, thus generating a further efficiency in performing the further queries.

Query combination module 706 combines (e.g., chains or otherwise concatenates) queries from upstream cells into a next cell when that cell is generated and run. To illustrate this, imagine the following sequence of cells within a query mode, each cell dependent on its prior cell based on it calling data from the prior cell:
Cell 1: pull flight_data dataframe from Postgres
Cell 2: select all public flights from flight_data
Cell 3: find all flights in the output of cell 2 that have 300 passengers that have at least 300 passengers
Cell 4: based on the output of cell 3, find all flights from the public flights that have between 300 and 500 passengers.
Cell 5: generate a chart representing airlines as charted against total number of passengers based on the flights output by the function of cell 4.

If query mode was not being used, each of these cells would be run independently from the kernel memory, all flights would be downloaded from execution of cell 2, and then cells 3 and 4 would be executed against what was downloaded in memory. Because query mode is being used, the kernel stores prior queries and query code commands that were sent to the relevant data warehouse 140 (e.g., based on activities performed by context module 206). Therefore, when cell 2 is run, flight_data is already known to be accessed using memory of the data warehouse 140 and that there is no need to download flight_data. The accessed data is filtered for public flights within the data warehouse by combining queries in subsequent cells. That is, query combination module 706 combines into the cell 2 query a pointer to what was already pulled from cell 1. This continues, where when cell 3 is run, query combination module 706 translates the code cell into query language for use in the data warehouse using the data connector where the query language references the query from cell 2 along with a filter to at least 300 passengers from cell 3. Moving to cell 4, query combination module 706 translates the code cell into query language for use with the data warehouse using the data connector where the query language references the cell 3 query and applies an additional filter of less than 500 passengers.

Kernel execution decision module 708 determines whether to run a cell using resources of data warehouse 140 or using kernel resources. Kernel execution decision module 708 may perform this determination based on attributes of the cell and/or context information relating to the cell and its dependencies. When performing the decision based on attributes of the cell, kernel execution decision module 708 may determine whether running the cell involves a function satisfying a rule. For example, a rules table may be stored by query mode module 208 (e.g., to context datastore 250) that maps function types to data warehouses, the functions being those that a data warehouse is designed to optimally perform. Exemplary types of functions that data warehouses are typically designed to efficiently perform include pivot and filtering functions on a dataframe, though any function may be mapped for performance by a data warehouse. Responsive to determining that running the cell involves a function that is mapped by such a rules table to the data warehouse acting on the dataframe on which the function applies, kernel execution decision module 708 may determine to run the cell using resources of data warehouse 140. Responsive to determining that the function is not mapped to the data warehouse, kernel execution decision module 708 may determine to run the cell using kernel resources of notebook application 111.

Following from the five-cell example above, cells 1-4 are best performed by using resources of a data warehouse, given that they perform dataframe pull and filter functions (e.g., which may be named by a rules table in association with a postgres data warehouse). Therefore, kernel execution decision module 708 determines to perform query combinations using query combination module 706 when running these cells. However, when running cell 5, kernel execution decision module 708 may determine to generate the chart using kernel resources. In general, generating charts and other user interface data representations from dataframe data is something data warehouses are not optimized to do. Kernel execution decision module 708 may make this determination based on chart generation not being listed on the aforementioned rules table or other data structure that maps the function to the data warehouse. Accordingly, query mode module 208 may run the cell using kernel resources, acting on the manipulated and filtered data frame from cell 4. This results in kernel resources (e.g., running cell 5 in python), which are far more limited and computationally expensive to use than data warehouse resources, only being used where absolutely necessary to perform functionality that a data warehouse is not equipped to perform or is inefficient at performing.

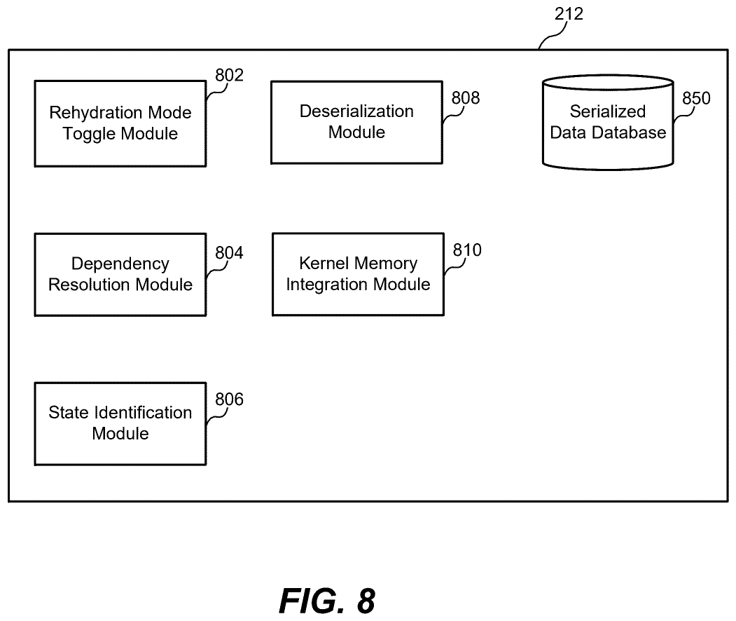

FIG. 8 is an example architecture of a serialization module 210, in accordance with one or more embodiments. The serialization module 210 includes a rehydration mode toggle module 802, dependency resolution module 804, state identification module 806, a deserialization module 808, and a kernel memory integration module 810, and serialized data database 850. The sub-modules and databases depicted with respect to FIG. 8 are merely exemplary, and more or fewer modules and/or databases may be used to achieve the functionality disclosed herein.

Rehydration mode toggle module 802 manages the toggle between rehydration mode and execution mode based on the state of the cells in the notebook and/or user inputs. The dependency resolution module 804 is configured to analyze the DAG of the notebook to identify cells precedent to a current cell that is to be executed or rehydrated. State identification module 806 is configured to determine whether a cell is stale, not stale, or fresh. The deserialization module 808 is configured to retrieve the serialized data from the serialized data database 850 and converts the serialized data from a serialized format into an in-memory format. The kernel memory integration module 810 is configured to integrates deserialized data into the kernel's memory to restore the execution state of a cell without re-execution.

In some embodiments, the notebook tool 130 may have a rehydration mode and an execution mode. Rehydration mode is a mode in which the system enables restoration of previously serialized computational states of notebook cells into the kernel memory without re-executing the cells. Execution mode is a mode in which the system executes notebook cells by the kernel. In some embodiments, there may be a UI element (e.g., a toggle switch, a drop down list, or other input format) on a GUI that allows a user to switch between a rehydration mode and execution mode.

Referring back to FIG. 4B, assuming a user requests to execute cell 4 (print(z)). The rehydration mode toggle module 802 determines whether the notebook tool 130 is in rehydration mode or execution mode. The determination of the mode may be based on user configuration or the availability of serialized data for rehydration. For example, if no serialized data is available for rehydration, the rehydration mode toggle module 802 may automatically set the mode to execution mode. In some embodiments, if serialized data is available for rehydration, the rehydration mode toggle module 802 may automatically set the default mode to rehydration mode. Responsive to determining that the notebook tool 130 is in execution mode, all cells will be executed or re-executed. This behavior is similar to the operation of conventional notebooks and will not be further described here.

Responsive to determining that the notebook tool 130 is in rehydration mode, the dependency resolution module 804 analyzes the DAG to determine dependencies for executing cell 4. The dependency resolution module 804 identifies that cell 4 depends on the output of cell 3, which in turn depends on cells 1 and 2. In some embodiments, the dependency resolution module 804 traverses the DAG and establishes a dependency chain: cell 4→cell 3→cell 2→cell 1. The state identification module 806 determines whether cells 1, 2, and 3 are fresh, stale, or not stale. For cell 1, if x=1 remains unchanged since its last execution, it is considered not stale. For cell 2, if y=x+1 has not been changed since its previous execution with x=1, cell 2 is also not stale. For cell 3, if z=y*2+x has not been changed since its previous execution with x=1, and y=x+1, cell 3 is also not stale. Based on these determinations, the dependency resolution module 804 determines that all of the precedent cells, cells 1-3, are not stale, and can be rehydrated.

The dependency resolution module 804 the causes the deserialization module 808 to deserialize these precedent cells. In some embodiments, the dependency resolution module 804 may further determine a minimal set of precedent cells that are to be deserialized for the purpose of executing the current cell (e.g., cell 4). Here, only cell 3 is required to execute cell 4. Thus, the dependency resolution module 804 may cause the dependency resolution module 804 to only deserialize the minimal set of precedent cells (e.g., only cell 3). During deserialization, the serialized data in a serialized format (e.g., in JSON or binary format) is converted into an in-memory data structure, such as a Python object or a Pandas data frame, for use by the kernel.

The kernel memory integration module 810 loads the deserialized data (e.g., z in cell 3) into the kernel's memory, and makes it available for cell 4's execution. As such, the notebook tool 130 is able to execute cell 4 without re-execution of its precedent cells 1, 2, or 3.

Notably, in some cases, some of the precedent cells may be stale. For example, if cell 3 is determined to be stale, the state identification module 806 may determine that cell 3 should not be rehydrated but instead re-executed before executing cell 4. Cell 3 can become stale in various scenarios, including updates or re-executions of its upstream or precedent cells (cells 1 and 2), modifications to its dependencies, direct edits to its code, external changes affecting its inputs, or manual invalidations. For instance, if cell 1 or cell 2 is modified (e.g., their code is altered or new values are assigned), cell 3 becomes stale as its computations are no longer synchronized with the updated precedent cells.

Additionally, if the dependencies of cell 3 are changed—such as adding a new dependency or removing an existing one—cell 3 becomes stale due to its altered execution context. This type of dependency change may result from edits made to the code within cell 3 itself. For example, if the code in cell 3 is modified from z=y*2+x to z=2*x, the cell becomes stale because its previous output is invalid and its dependencies (cell 1 and/or cell 2) may no longer be relevant.

If the state identification module 806 determines that cell 3 must be re-executed due to one or more of the aforementioned reasons (or different reasons), the module 806 also evaluates the states of its precedent cells (cells 1 and 2) to determine whether they require rehydration or re-execution. For example, if neither cell 1 nor cell 2 is stale, the state identification module 806 may instruct the rehydration of both cells before proceeding with the execution of cell 3. Alternatively, if cell 1 is not stale but cell 2 is stale, the state identification module 806 may decide to rehydrate cell 1 and re-execute cell 2 prior to executing cell 3.

In scenarios with complex dependencies, this process may be performed iteratively or recursively to identify the minimal set of cells that require rehydration and the minimal set of cells that require re-execution, ensuring optimal preparation before executing the target cell.

In addition to the states of precedent cells, the state identification module 806 or the notebook tool 130 may also consider other factors in determining whether a cell should be rehydrated or re-executed. Such factors may include computational costs, data size and complexity, and type of operation performed by the cell. For example, in some embodiments, if rehydration (deserialization from disk) is computationally faster than re-execution, rehydration may be preferred. On the other hand, for cells performing lightweight operations, re-execution may be quicker and easier than deserializing, thus, re-execution may be preferred. Alternatively, or in addition, for large datasets or outputs, rehydration from a serialized state may be faster and/or more memory-efficient than re-executing a cell, thus, rehydration may be preferred. Further, cells with random outputs or external dependencies (e.g., API calls, timestamps) may be re-executed to ensure accurate results. In some embodiments, users may be able to input their preference. For example, if a user selects a “rehydrate” or “re-execute” mode for a cell, that preference may override other considerations. In some embodiments, users may define custom execution modes to selectively rehydrate or re-execute based on their workflow needs.

In some embodiments, a rules table or heuristic algorithm may map certain functions or operations to either rehydration or re-execution. For example, data frame queries (SQL filters) may prefer rehydration; operations with random outputs may prefer re-execution. If an error occurred during a previous execution of a cell, re-execution may be required instead of rehydration to ensure proper results. In some embodiments, patterns from previous runs may influence the choice. For instance, cells rarely being modified might be better off rehydrated if results are serialized; if a user frequently modifies certain cells, re-execution may be preferred for those cells.

In some embodiments, the decision to rehydrate or re-execute may depend on current system resources, such as CPU, memory, or disk I/O constraints. If multiple users are collaborating on a same notebook, the system may prioritize rehydration to ensure consistency across users. For cells that are part of a query chain in a data warehouse, rehydration may be preferred to leverage cached results. If the query results are already optimized for the data warehouse schema, rehydration may be faster than recomputing within the kernel.

In some embodiments, the system may have a local rehydration mode, a local execution mode, a query execution mode, and a query rehydration mode. The local rehydration mode is a mode where the system retrieves serialized states from local storage (e.g., a disk coupled to the notebook application or notebook tool) and restores them into the kernel memory. The local execution mode is a mode where notebook cells are executed within the kernel 132 of the notebook using locally available resources, such as the processor 134 (e.g., CPU, GPU) and memory 135. The query execution mode is a mode where the system offloads the execution of notebook cells to an external data warehouse 140. The notebook tool 130 dynamically determines whether a cell's operations (e.g., large-scale data queries) are better suited for execution in the data warehouse. The query rehydration mode is a mode where the system retrieves serialized query results from a data warehouse, deserializes them, and integrates them into the kernel for use in subsequent computations.

To illustrate how these different modes work, imagine the following sequence of cells within a query mode, each cell dependent on its prior cell based on it calling data from the prior cell:
Cell 1: pull flight_data dataframe from Postgres
Cell 2: select all public flights from flight_data
Cell 3: find all flights in the output of cell 2 that have 300 passengers that have at least 300 passengers
Cell 4: based on the output of cell 3, find all flights from the public flights that have between 300 and 500 passengers.
Cell 5: generate a chart representing airlines as charted against total number of passengers based on the flights output by the function of cell 4.

The rehydration mode toggle module 802 manages switching between these various modes (local rehydration, local execution, query execution, query rehydration) based on the state of the cells and/or notebook tool configurations. Suppose the system receives a request to run cell 5 (generate a chart). The rehydration mode toggle module 802 determines the operational mode of the notebook tool 130. Local execution and query execution modes operate in a manner similar to the execution mode and query mode described previously in conjunction with FIG. 7, and thus will not be further discussed. Likewise, the local rehydration mode operates in a manner similar to the rehydration mode described previously in conjunction to FIG. 4B, and will also not be further described.

Responsive to determining that the mode is query rehydration mode, the dependency resolution module 804 analyzes the DAG representing the dependencies between notebook cells to identify which cells are precedent to the current cell (cell 5). Cell 5 depends on the output of cell 4, which depends on the output of cell 3, which in turn depends on cells 2 and 1. The dependency resolution module 804 traverses the DAG to identify all the dependencies (cells 1-4).

The state identification module 806 determines the state of each precedent cells (cells 1-4)—whether it is fresh, stale, or not stale. The state identification module checks the states of cell 1-4. If cells 1-2 are “not stale” (previously executed and unchanged), the module 806 marks them for rehydration. If cell 3 is “stale” (e.g., due to an edit in its code or dependency), the module 806 flags it for re-execution. This ensures that only necessary computations are performed, saving time and resources.

In query rehydration mode, the deserialization module 808 retrieves serialized state (e.g., outputs or intermediate results) from the data warehouse 140, and deserializes these states into an in-memory data structure that can be directly used by the kernel. The kernel memory integration module 810 can then integrates the deserialized data back into the kernel's memory. For example, after deserialization, the kernel memory integration module 808 loads the output of cell 1 (flight_data) and cell 2 (public flights) into the kernel's memory. This allows cell 3 to perform its filtering operation using rehydrated data.

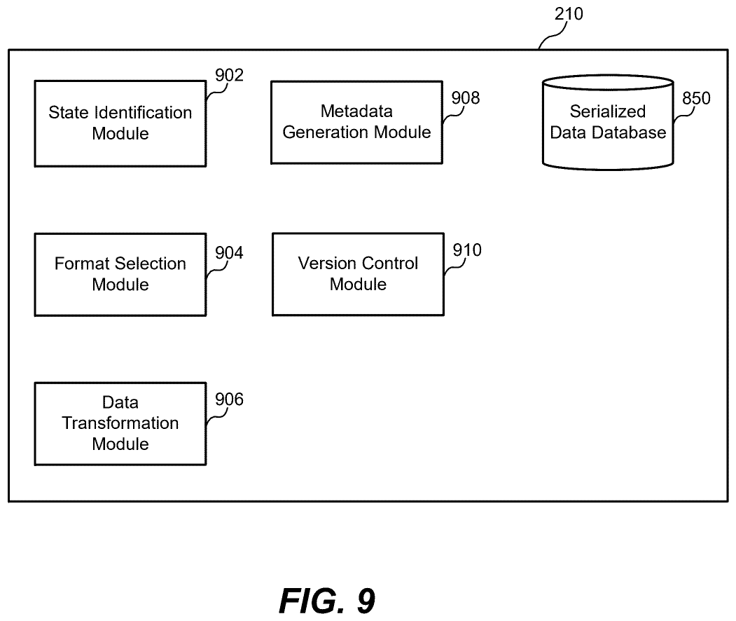

FIG. 9 is an example architecture of a serialization module 210, in accordance with one or more embodiments. The serialization module 210 includes a state identification module 902, a format selection module 904, a data transformation module 906, a metadata generation module 908, a version control module 910, and a serialized data database 850. The sub-modules and databases depicted with respect to FIG. 9 are merely exemplary, and more or fewer modules and/or databases may be used to achieve the functionality disclosed herein.

The state identification module 902 identifies specific computational states, data structures or variables in memory that need to be serialized. In some embodiments, the module 902 scans the in-memory state of notebook cells to determine the relevant objects for serialization, such as variables, data frames, or intermediate results. The module 902 may filter out irrelevant or redundant data to minimize storage requirement for serialization, and ensures that all necessary execution context is preserved for rehydration later.

The format selection module 904 is configured to select a proper serialization format based on the type and structure of the data to be serialized. The module 904 may determine the most efficient format for the data (e.g., binary for compactness or JSON for readability). The module 904 may support a variety of serialization formats, such as binary formats (e.g., Pickle, Protocol Buffers) for compact and efficient storage of Python objects, text-based formats (e.g., JSON, XML, CSV) for compatibility and data exchange, domain-specific formats (e.g., Parquet) for tabular data that needs to be queried efficiently. In some embodiments, the serialization format may be configured by users, and the format selection module 904 selects serialization formats based on the user configuration.

Data transformation module 906 is configured to transform the in-memory data into the chosen serialized format. In some embodiments, the module 906 applies transformations such as compression to reduce storage size, encoding or encrypting sensitive data for security, flattening hierarchical data structures for simpler storage, etc.

The metadata generation module 908 is configured to generate metadata associated with the serialized data to support rehydration, versioning, and dependency tracking. In some embodiments, the module 908 may attach information such as timestamps indicating when the data was serialized, data dependencies, such as relationships between cells in a DAG, contextual information about the data (e.g., variable names, data types). The metadata facilitates proper rehydration by providing the context for deserializing and integrating the data back into the notebook computational environment.

The version control module 910 is configured to manage versions of serialized states to ensure compatibility and support collaborative workflows. In some embodiments, the version control module 910 tracks changes to serialized data over time, creating a version history, which enables users or systems to revert to previous versions or reconcile conflicts between different versions. The module 910 also ensures consistency when serialized data is accessed or modified across multiple sessions or users.

For example, referring back to FIG. 4B, after executing cell 4 (print (z)), the notebook tool may serialize the computational state of cell 4 so that its output can be rehydrated later without re-executing any of the preceding cells. The state identification module 902 identifies the data and context produced by cell 4 that require serialization. The format selection module 904 selects an appropriate format to serialize the output and associated context. Since the output of cell 4 is a numeric value (z=4), a binary format such as Pickle may be chosen for its compactness and efficiency. The data transformation module 906 converts the identified state into the selected serialized format. For instance, the output of cell 4 (value 4) may be transformed into a binary file. The metadata generation module 908 attaches metadata to the serialized data. This metadata may include, but is not limited to, the timestamp of serialization, DAG dependencies, and contextual information (e.g., z was computed using y*2+x). The version control module 910 tracks and manages different versions of the serialized state. For example, if the code in cell 4 changes or any dependencies are updated, a new version of the serialized state is created. For example,
version 1: z=x+y, output: z=3;
version 2: z=y*2+x, output: z=4.

### Computing Machine Architecture

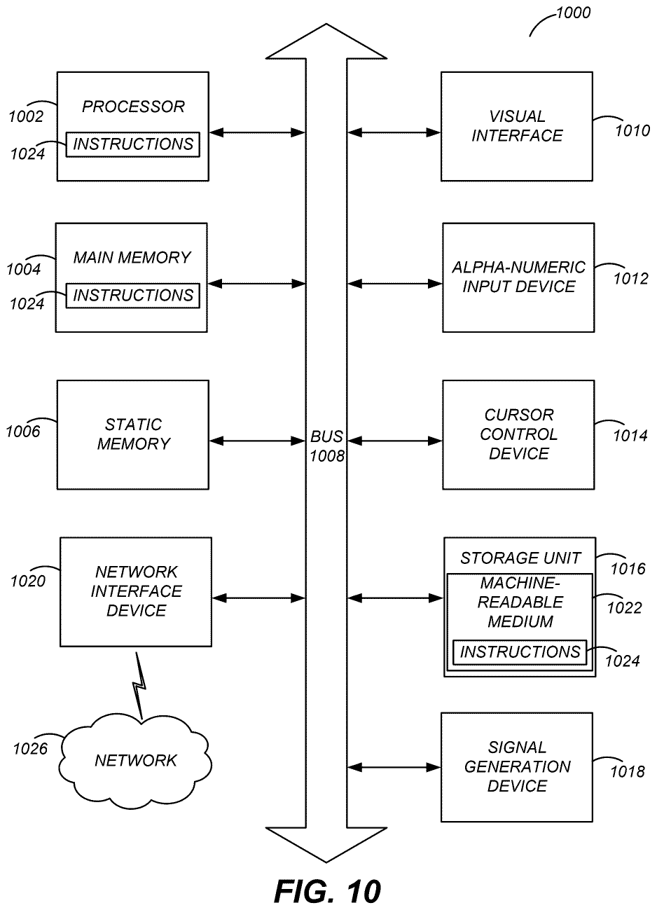

FIG. 10 is a block diagram illustrating components of an example machine able to read instructions from a machine-readable medium and execute them in a processor (or controller). Specifically, FIG. 10 shows a diagrammatic representation of a machine in the example form of a computer system 1000 within which program code (e.g., software) for causing the machine to perform any one or more of the methodologies discussed herein may be executed. The program code may be comprised of instructions 1024 executable by one or more processors 1002. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1024 (sequential or otherwise) that specify actions to be taken by that machine. Further, while only a single machine is illustrated, the term “machine” shall also be taken to include any collection of machines that individually or jointly execute instructions 1024 to perform any one or more of the methodologies discussed herein.

The example computer system 1000 includes a processor 1002 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1004, and a static memory 1006, which are configured to communicate with each other via a bus 1008. The computer system 1000 may further include visual display interface 1010. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 1010 may include or may interface with a touch enabled screen. The computer system 1000 may also include alphanumeric input device 1012 (e.g., a keyboard or touch screen keyboard), a cursor control device 1014 (e.g., a mouse, a trackball, a joystick, a motion sensor, or other pointing instrument), a storage unit 1016, a signal generation device 1018 (e.g., a speaker), and a network interface device 1020, which also are configured to communicate via the bus 1008.

The storage unit 1016 includes a machine-readable medium 1022 on which is stored instructions 1024 (e.g., software) embodying any one or more of the methodologies or functions described herein. The instructions 1024 (e.g., software) may also reside, completely or at least partially, within the main memory 1004 or within the processor 1002 (e.g., within a processor's cache memory) during execution thereof by the computer system 1000, the main memory 1004 and the processor 1002 also constituting machine-readable media. The instructions 1024 (e.g., software) may be transmitted or received over a network 1026 via the network interface device 1020.

While machine-readable medium 1022 is shown in an example embodiment to be a single medium, the term “machine-readable medium” should be taken to include a single medium or multiple media (e.g., a centralized or distributed database, or associated caches and servers) able to store instructions (e.g., instructions 1024). The term “machine-readable medium” shall also be taken to include any medium that is capable of storing instructions (e.g., instructions 1024) for execution by the machine and that cause the machine to perform any one or more of the methodologies disclosed herein. The term “machine-readable medium” includes, but not be limited to, data repositories in the form of solid-state memories, optical media, and magnetic media.

### Example Method for Dynamic Computational State Rehydration

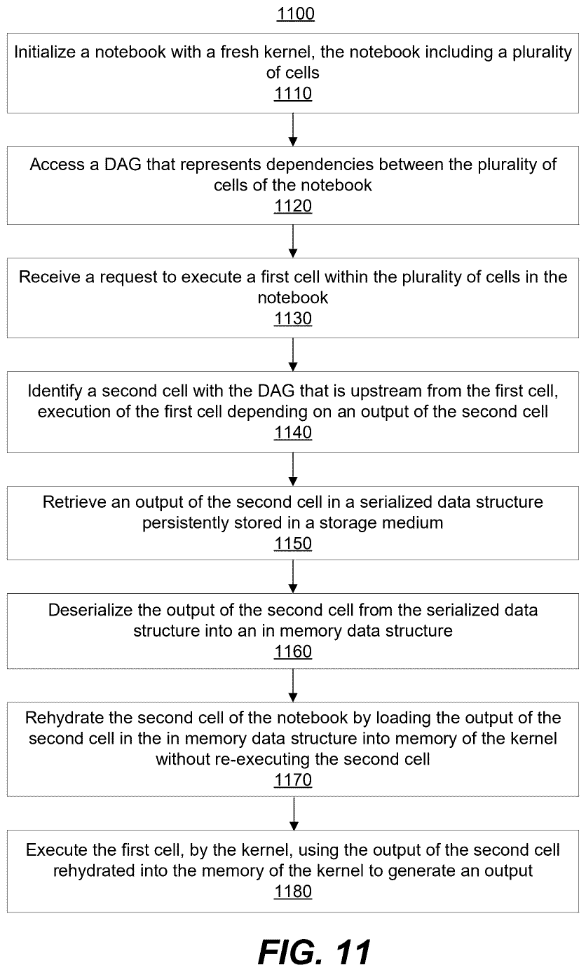

FIG. 11 is a flowchart of an example method 1100 for dynamic computational state rehydration in a notebook environment, in accordance with one or more embodiments. In various embodiments, the method includes different or additional steps than those described in conjunction with FIG. 11. Further, in some embodiments, the steps of the method may be performed in different orders than the order described in conjunction with FIG. 11. The method described in conjunction with FIG. 11 may be carried out by a system, such as the notebook tool 130 in various embodiments, while in other embodiments, the steps of the method are performed by a combination of the client device 110, the data warehouse 140 and/or the notebook tool 130.

The system initializes 1110 a notebook with a fresh kernel. For example, in some embodiments, when a user opens a notebook, a notebook environment may launch a fresh kernel automatically. Alternatively, the notebook environment may prompt the user to select a specific kernel based on the computational demand, the programming language associated with the notebook (e.g., Python, R, Julia) or other factors. The selected kernel is launched as a process by the notebook tool. This process may include allocating memory for the kernel to operate, initializes the runtime environment for the selected programming language or framework, and setting up communication channels between the notebook interface and the kernel. When a fresh kernel starts, the memory normally has no prior states or variables or execution contexts from previous sessions. The kernel is associated with the notebook session and begins listening for commands sent from the notebook cells.

The notebook includes multiple cells. Each cell, when executed, performs a computational operation. In some embodiments, the computation operations may include (but are not limited to) data manipulation and transformation, such as data loading (e.g., importing datasets from files, databases, APIs, or cloud storage), data cleaning (e.g., handling missing values, outliers, and inconsistencies in dataset), and data transformation (e.g., filtering, aggregating, joining, pivoting, or reshaping datasets,). In some embodiments, the computation operations may also include mathematical and statistical computations, such as arithmetic operations, matrix operations, statistical analysis. In some embodiments, the computation operations may also include machine learning and artificial intelligence algorithms, such as model training, model evaluation, feature engineering. In some embodiments, the computation operations may also include data visualization, such as creating charts, graphs, and/or plots, and generating interactive visualizations with tools. In some embodiments, the computational operations may also include query executions, such as SQL queries, NoSQL queries, graph queries, among others.

The system accesses 1120 a DAG that represents dependencies between the multiple cells of the notebook. Each cell in the notebook corresponds to a node in the DAG, and the directed edges between these nodes represent dependencies where the output or state of one cell is required for the execution of another. FIGS. 4A and 4B illustrate dependencies and DAG of example cells. To execute a cell, all its upstream dependencies (also referred to as precedent cells) must be resolved first. Further, if a cell's output changes, all downstream cells dependent on that cell must be re-evaluated to maintain consistency.

The system receives 1130 a request to execute a cell (also referred to as a “first cell”) within the multiple cells in the notebook. For example, a user may select the cell and click “Run” in the notebook interface. Alternatively, a user may select multiple cells, including the cell, and execute them sequentially. In some embodiments, the execution of a cell may be triggered by another program. For example, a script or an external program may call the notebook system to execute the cell as a part of a larger automated workflow or pipeline. Alternatively, an API request from another system may trigger the notebook to execute the cell.

The system identifies 1140 a second cell within the DAG that is upstream from the first cell. The execution of the first cell depends on an output of the second cell. In some embodiments, the system traverses the DAG to identify all nodes that have a directed edge pointing toward the first cell, and determines the cells corresponding to these nodes are the cells that are upstream from the first cell. In some embodiments, the system recursively explores upstream nodes in the DAG, following directed edges, to identify all dependent cells. The system stops after it identifies a cell that directly provides the output needed by the first cell and its other precedent cells. In some embodiments, the system identifies a minimal set of upstream cells that must be resolved before the execution of the first cell. In some embodiments, the system receives a user input indicating a request to explore from the cell in the notebook. Responsive to the user input, the system identifies the minimal set of cells.

The system retrieves 1150 an output of the second cell in a serialized data structure persistently stored in a storage medium. In some embodiments, the system may use metadata associated with the second cell to identify the location and format of its serialized output. This metadata may include a cell identifier, a file path where the serialized data is stored, a format of the serialized data (e.g., JSON, Parquet, Pickle). If the storage medium (e.g., disk, cloud storage, database) has an indexing system, the system may query the index to locate the serialized data.

The system deserializes 1160 the output of the second cell from the serialized data structure into an in memory data structure, and rehydrates 1170 the second cell of the notebook by loading the output of the second cell in the in memory data structure into memory of the kernel without re-executing the second cell. In some embodiments, the system performs format-specific parsing of the serialized data based on the format of the serialized data. The system then reconstructs the serialized objects into in-memory representations such as, variables, lists, arrays, dictionaries, data frames or other data structures. The system may then assign the deserialized in-memory structure to the execution context of the kernel to rehydrate the second cell. For example, a data frame output is stored as a variable in the kernel's memory; a computed value or intermediate state may be reinstated into the kernel's state.

The system then causes the kernel to execute 1180 the first cell using the output of the second cell rehydrated into the memory of the kernel to generate an output. In some embodiments, the system also serializes the output of the first cell from an in memory data structure into a serialized data structure, and stores the output in the serialized data structure persistently in the storage medium. As such, in a next session, a fresh kernel can rehydrate the first cell without re-execution as long as the first cell is not stale.

In some embodiments, the system also determines whether the serialized output of the second cell is stale. Responsive to determining that the serialized output of the second cell is not stale, the system deserializes the output of the second cell; otherwise, the system re-executes the second cell. In some embodiments, determining whether the serialized output of the second cell is stale includes comparing a timestamp of the serialized output of the second cell with a timestamp of a most recent execution of the second cell to determine whether the serialized output of the second cell is stale.

In some embodiments, the system may also determine a computational complexity of the second cell. Responsive to determining that the computational complexity of the second cell is greater than a threshold, the system rehydrates the second cell; otherwise, the system re-executes the second cell.

In some embodiments, the system may also determine a data size associated with the computational operation of the second cell. Responsive to determining that the data size is greater than a threshold, the system rehydrates the second cell; otherwise, the system re-executes the second cell.

In some embodiments, the system may also determine a type of the computational operation associated with the second cell, and determines whether rehydrating or re-executing the second cell based on the determined type of computational operation. For example, in some embodiments, in response to determining that the type of the computational operation of the second cell is related to data retrieval and manipulation, the system rehydrates the second cell. As another example, in some embodiments, in response to determining that the type of the computational operation of the second cell is related to a randomized operation, the system re-executes the second cell.

The embodiments described herein enable dynamic rehydration of notebook cells without re-execution, which significantly improves computational efficiency by leveraging previously serialized computational states. Instead of re-running all upstream dependencies, the system identifies and retrieves relevant outputs stored in a persistent storage medium, deserializes them into an in-memory structure, and seamlessly integrates these outputs into the kernel's active memory. This reduces redundant computations, as cells that have not been modified or invalidated do not need to be re-executed. By eliminating the need for repeated execution of upstream cells, the system conserves computational resources such as CPU cycles, memory usage, and disk I/O operations. Moreover, this approach enhances the speed and interactivity of the notebook environment, allowing users to work with large datasets or complex workflows more efficiently. The reduction in redundant processes also makes the system scalable for use in distributed or collaborative environments, where multiple users or systems may rely on the same notebook workflows.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for generating code for cells having dependencies shown in a DAG using generative AI through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for dynamic computational state rehydration in a directed acyclic graph (DAG)-based notebook environment, comprising:
initializing a notebook with a fresh kernel, the notebook including a plurality of cells, wherein each cell, when executed, performs a computational operation;
accessing a DAG that represents dependencies between the plurality of cells of the notebook;
receiving a request to execute a first cell within the plurality of cells in the notebook;
identifying a second cell within the DAG that is upstream from the first cell, wherein execution of the first cell depends on an output of the second cell;
retrieving an output of the second cell in a serialized data structure persistently stored in a storage medium;
deserializing the output of the second cell from the serialized data structure into an in memory data structure;
rehydrating the second cell of the notebook by loading the output of the second cell in the in memory data structure into memory of the kernel without re-executing the second cell; and
executing the first cell, by the kernel, using the output of the second cell rehydrated into the memory of the kernel to generate an output.

2. The method of claim 1, further comprising:
serializing the output of the first cell from an in memory data structure into a serialized data structure; and
storing the output in the serialized data structure persistently in the storage medium.

3. The method of claim 1, further comprising:
identifying a minimal set of cells within the DAG that is directly upstream from the first cell, wherein execution of the first cell by the kernel directly depends on outputs of the minimal set of cells; and
for each cell in the minimal set,
deserializing an output of the second cell in a serialized data structure stored in the storage medium into an in memory data structure; and
rehydrating the cell of the notebook environment by loading the output of the second cell in the in memory data structure into the memory of the kernel without re-executing the cell.

4. The method of claim 3, further comprising:
receiving a user input indicating a request to explore from the first cell in the notebook;
responsive to the user input, identifying the minimal set of cells and rehydrating the minimal set of cells.

5. The method of claim 1, further comprising:
determining whether the serialized output of the second cell is stale;
responsive to determining that the serialized output of the second cell is not stale, deserializing the output of the second cell; and
responsive to determining that that the serialized output of the second cell is stale, re-executing the second cell.

6. The method of claim 5, wherein determining whether the serialized output of the second cell is stale includes comparing a timestamp of the serialized output of the second cell with a timestamp of a most recent execution of the second cell to determine whether the serialized output of the second cell is stale.

7. The method of claim 1, further comprising:
determining a computational complexity of the second cell;
responsive to determining that the computational complexity of the second cell is greater than a threshold, rehydrating the second cell; and
responsive to determining that the computational complexity of the second cell is no greater than the threshold, re-executing the second cell.

8. The method of claim 1, further comprising:
determining a data size associated with the computational operation of the second cell;
responsive to determining that the data size is greater than a threshold, rehydrating the second cell; and
responsive to determining that the data size is no greater than the threshold, re-executing the second cell.

9. The method of claim 1, further comprising:
determining a type of the computational operation associated with the second cell;
determining whether rehydrating or re-executing the second cell based on the determined type of computational operation.

10. The method of claim 9, further comprising
in response to determining that the type of the computational operation of the second cell is related to data retrieval and manipulation, rehydrating the second cell.

11. The method of claim 9, further comprising
in response to determining that the type of the computational operation of the second cell is related to a randomized operation, re-executing the second cell.

12. A non-transitory computer-readable medium comprising memory with instructions encoded thereon, the instructions, when executed by one or more processors, causing the one or more processors to perform steps comprising:
initializing a notebook with a fresh kernel, the notebook including a plurality of cells, wherein each cell, when executed, performs a computational operation;
accessing a DAG that represents dependencies between the plurality of cells of the notebook;
receiving a request to execute a first cell within the plurality of cells in the notebook;
identifying a second cell within the DAG that is upstream from the first cell, wherein execution of the first cell depends on an output of the second cell;
retrieving an output of the second cell in a serialized data structure persistently stored in a storage medium;
deserializing the output of the second cell from the serialized data structure into an in memory data structure;
rehydrating the second cell of the notebook by loading the output of the second cell in the in memory data structure into memory of the kernel without re-executing the second cell; and
executing the first cell, by the kernel, using the output of the second cell rehydrated into the memory of the kernel to generate an output.

13. The non-transitory computer-readable medium of claim 12, the steps further comprising:
serializing the output of the first cell from an in memory data structure into a serialized data structure; and
storing the output in the serialized data structure persistently in the storage medium.

14. The non-transitory computer-readable medium of claim 12, the steps further comprising:
identifying a minimal set of cells within the DAG that is directly upstream from the first cell, wherein execution of the first cell by the kernel directly depends on outputs of the minimal set of cells; and
for each cell in the minimal set,
deserializing an output of the second cell in a serialized data structure stored in the storage medium into an in memory data structure; and
rehydrating the cell of the notebook by loading the output of the second cell in the in memory data structure into the memory of the kernel without re-executing the cell.

15. The non-transitory computer-readable medium of claim 14, the steps further comprising:
receiving a user input indicating a request to explore from the first cell in the notebook;
responsive to the user input, identifying the minimal set of cells and rehydrating the minimal set of cells.

16. The non-transitory computer-readable medium of claim 12, the steps further comprising:
determining whether the serialized output of the second cell is stale;
responsive to determining that the serialized output of the second cell is not stale, deserializing the output of the second cell; and
responsive to determining that that the serialized output of the second cell is stale, re-executing the second cell.

17. The non-transitory computer-readable medium of claim 16, wherein determining whether the serialized output of the second cell is stale includes comparing a timestamp of the serialized output of the second cell with a timestamp of a most recent execution of the second cell to determine whether the serialized output of the second cell is stale.

18. The non-transitory computer-readable medium of claim 12, the steps further comprising:
determining a computational complexity of the second cell;
responsive to determining that the computational complexity of the second cell is greater than a threshold, rehydrating the second cell; and
responsive to determining that the computational complexity of the second cell is no greater than the threshold, re-executing the second cell.

19. The non-transitory computer-readable medium of claim 12, the steps further comprising:
determining a data size associated with the computational operation of the second cell;
responsive to determining that the data size is greater than a threshold, rehydrating the second cell; and
responsive to determining that the data size is no greater than the threshold, re-executing the second cell.

20. A computing system, comprising:
one or more processors; and
a non-transitory computer-readable medium comprising memory with instructions encoded thereon, the instructions, when executed by the one or more processors, causing the one or more processors to perform steps comprising:
initializing a notebook with a fresh kernel, the notebook including a plurality of cells, wherein each cell, when executed, performs a computational operation;
accessing a DAG that represents dependencies between the plurality of cells of the notebook;
receiving a request to execute a first cell within the plurality of cells in the notebook;
identifying a second cell within the DAG that is upstream from the first cell, wherein execution of the first cell depends on an output of the second cell;
retrieving an output of the second cell in a serialized data structure persistently stored in a storage medium;
deserializing the output of the second cell from the serialized data structure into an in memory data structure;
rehydrating the second cell of the notebook by loading the output of the second cell in the in memory data structure into memory of the kernel without re-executing the second cell; and
executing the first cell, by the kernel, using the output of the second cell rehydrated into the memory of the kernel to generate an output.
